(19) United States
(12) Patent Application Publication
(10) Pub. No.: US 2024/0097210 A1
(43) Pub. Date: Mar. 21, 2024

(54) BATTERY PACK WITH ELECTRONICS COMPARTMENT

(71) Applicant: Apple Inc., Cupertino, CA (US)

(72) Inventors: Nivay Anandarajah, San Leandro, CA (US); Evan D. Maley, Redwood City, CA (US); Matthew I Woods, Los Gatos, CA (US); Dylan C. Erb, San Jose, CA (US); Abraham B. Caulk, Livermore, CA (US); Joseph D. Rainey, Sunnyvale, CA (US); John M. Schoech, San Jose, CA (US)

(21) Appl. No.: 17/950,055

(22) Filed: Sep. 21, 2022

(51) Int. Cl. H01M 10/42; H01M 50/204; H01M 50/233

(52) U.S. Cl. CPC H01M 10/425; H01M 50/204; H01M 50/233

(57) ABSTRACT

A battery pack includes a housing defining a housing interior, a first stack of electrochemical cells disposed in the housing interior, a second stack of electrochemical cells disposed in the housing interior, and an electronics compartment disposed in the housing interior. The electronics compartment is positioned between the first stack of electrochemical cells and the second stack of electrochemical cells. Further, the electronics compartment extends along a majority of a length of the battery pack.

### BACKGROUND

The present disclosure relates generally to a battery pack, and more specifically to componentry of the battery pack, such as access panels, structural beams, an electronics compartment, and other componentry of the battery pack.

A battery pack may include a number of electrochemical cells, such as lithium-ion cells, configured to generate a charge having a voltage and current for powering a load. For example, the electrochemical cells may be coupled in series such that individual voltages of the electrochemical cells are combined to generate a charge having a total voltage, or in parallel such that individual currents of the electrochemical cells are combined to generate a charge having a total current. In some embodiments, series and parallel couplings are employed between various electrochemical cells of the battery pack to generate a total voltage and total current compatible with the load receiving the charge.

In traditional configurations, the battery pack may be packaged in a manner that unnecessarily or undesirably contributes to a height of the battery pack. Further, the battery pack may be packaged in a manner that limits serviceability of the battery pack and/or a structural integrity of the battery pack. Accordingly, it is now recognized that improved battery packs are desired.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment of the present disclosure, a battery pack includes a housing defining a housing interior, a first stack of electrochemical cells disposed in the housing interior, a second stack of electrochemical cells disposed in the housing interior, and an electronics compartment disposed in the housing interior. The electronics compartment is positioned between the first stack of electrochemical cells and the second stack of electrochemical cells. Further, the electronics compartment extends along a majority of a length of the battery pack.

In another embodiment of the present disclosure, a battery pack includes electrochemical cells and a housing defining a housing interior in which the electrochemical cells are disposed. The housing includes a panel having a first flat portion, a second flat portion, and a third portion disposed between the first flat portion and the second flat portion. The third portion extends from the first flat portion and the second flat portion toward an opposing panel of the housing such that the third portion defines a channel. The channel is defined along a surface of the panel facing outwardly from the housing interior.

In yet another embodiment of the present disclosure, a battery pack includes a housing defining a housing interior, electrochemical cells disposed in the housing interior, a first panel of the housing, and a second panel of the housing opposing the first panel of the housing. The battery pack also includes an access panel of the housing, where the access panel is coupled to the second panel about an access opening in the second panel. The battery pack also includes structural beams extending through the housing interior between the first panel and the second panel to support a mechanical load against the first panel.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a schematic diagram of an electrical system including one or more loads and a battery pack configured to power the one or more loads, according to embodiments of the present disclosure;

FIG. 2 is an exploded top perspective view of the battery pack of FIG. 1, including a housing and various componentry disposed in the housing, the componentry including a first stack of electrochemical cells, a second stack of electrochemical cells, and an electronics compartment between the first stack and the second stack, according to embodiments of the present disclosure;

FIG. 3 is an exploded bottom perspective view of the battery pack of FIG. 2, according to embodiments of the present disclosure;

FIG. 4 is a top cross-sectional perspective view of the battery pack of FIG. 2, according to embodiments of the present disclosure;

FIG. 5 is a cross-sectional front view of the battery pack of FIG. 2, according to embodiments of the present disclosure;

FIG. 6 is a top cross-sectional perspective view of the battery pack of FIG. 1, including an electronics compartment disposed on a top panel of a housing of the battery pack and extending along a width of the battery pack, according to embodiments of the present disclosure;

FIG. 7 is a cross-sectional perspective view of the battery pack of FIG. 6, according to embodiments of the present disclosure;

FIG. 8 is a top cross-sectional perspective view of the battery pack of FIG. 1, including an access panel coupled to a top panel of a housing of the battery pack, according to embodiments of the present disclosure;

FIG. 9 is a cross-sectional perspective view of the battery pack of FIG. 8, according to embodiments of the present disclosure;

FIG. 10 is a top cross-sectional perspective view of the battery pack of FIG. 1, including an electronics compartment disposed on (or extending through) a top panel of a housing of the battery pack and extending along a length of the battery pack, according to embodiments of the present disclosure; and

FIG. 11 is a cross-sectional perspective view of the battery pack of FIG. 10, according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on).

This disclosure is directed to a battery pack with various features that enable an improved serviceability, improved structural integrity, improved volumetric energy density, and/or a reduced height relative to traditional systems. For example, the battery pack may include a housing defining a housing interior and formed by various panels. The panels may include a top panel with first flat portion, a second flat portion, and a third portion extending downwardly from the first flat portion and the second flat portion to define a channel, recess, or groove configured to receive harness assemblies associated with the battery pack, one or more loads powered by the battery pack, or both.

Additionally or alternatively, the battery pack may include a bottom panel opposing the top panel, with an opening in the bottom panel and an access panel covering the opening. An electronics compartment of the battery pack may be aligned with the access panel and the opening in the bottom panel. Accordingly, electronic componentry disposed in the electronics compartment is readily accessible via removal of the access panel from the bottom panel. Additionally or alternatively, the electronics compartment may be disposed between a first stack of electrochemical cells of the battery pack and a second stack of electrochemical cells of the battery pack. A first structural beam may extend through a housing interior (e.g., from the top panel to the bottom panel) between the first stack of electrochemical cells and the electronics compartment, and a second structural beam may extend through the housing interior (e.g., from the top panel to the bottom panel) between the second stack of electrochemical cells and the electronics compartment. The above-described features may improve a volumetric energy density and reduce a height of the battery pack, while enabling the battery pack to support a mechanical load against the top panel of the housing. Further, a position of the access panel at the bottom panel of the housing may improve serviceability of the electronic componentry in the electronics compartment, as the top panel of the battery pack may be blocked from access by structural features corresponding to the load powered by the battery pack. These and other features will be described in detail below with reference to the drawings.

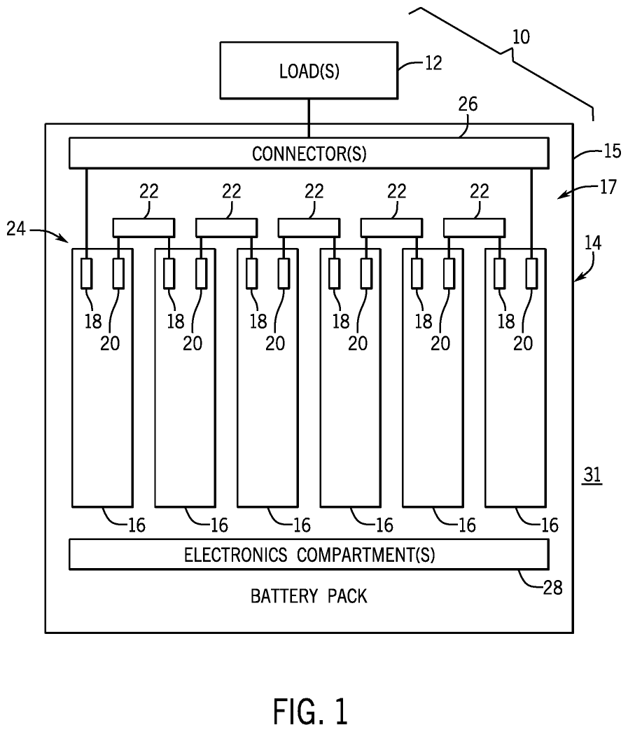

FIG. 1 is a schematic diagram of an embodiment of an electrical system 10 including one or more loads 12 and a battery pack 14 configured to power the one or more loads 12. As shown, the battery pack 14 may include a housing 15 and a number of electrochemical cells 16 disposed in a housing interior 17 defined by the housing 15, each electrochemical cell 16 having a first terminal 18 (e.g., positive terminal) and a second terminal 20 (e.g., negative terminal). The electrochemical cells 16 may be, for example, lithium-ion (Li-ion) cells, nickel-metal hydride (NiMH) cells, nickel-cadmium (NiCd) cells, lead-acid cells, or another type of rechargeable, secondary electrochemical cells. Bus bars 22 may be employed to couple various terminals 18, 20 of various electrochemical cells 16 (e.g., in series and/or in parallel) to form an interconnected group 24 of the electrochemical cells 16, where the interconnected group 24 of the electrochemical cells 16 is coupled to a connector 26 of the battery pack 14.

The connector 26 of the battery pack 14 may be coupled to the load 12 such that the battery pack 14 powers the load 12. Although the electrical system 10 in FIG. 1 illustrates the connector 26, the interconnected group 24 of electrochemical cells 16, and the load 12, it should be understood that multiple connectors, multiple interconnected groups of electrochemical cells, and multiple loads are also possible. For example, a first load may be powered by a first battery module (e.g., interconnected group of electrochemical cells) of the battery pack 14 via a first connector, and a second load may be powered by a second battery module (e.g., interconnected group of electrochemical cells) of the battery pack 14 via a second connector.

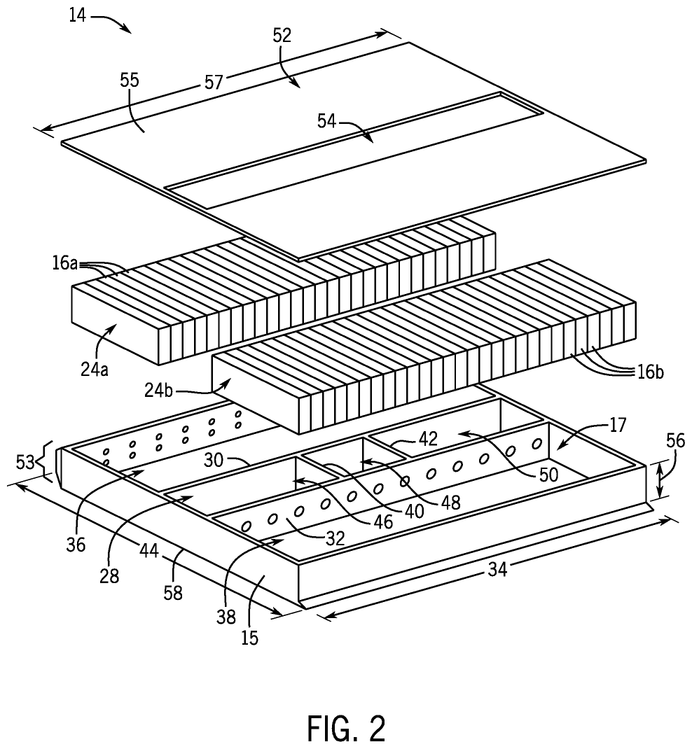

The battery pack 14 may also include an electronics compartment 28. In the illustrated embodiment, the electronics compartment 28 is disposed in the housing interior 17, although the electronics compartment 28 may be coupled to the housing 15 and/or extend into an external space 31 in another embodiment. As described in detail below with reference to FIGS. 2-11, various features of the battery pack 14 may be employed to reduce a height of the battery pack 14, improve a volumetric energy density of the battery pack 14, improve a structural integrity of the battery pack 14, improve serviceability of the battery pack 14, or any combination thereof relative to traditional embodiments.

FIG. 2 is an exploded top perspective view of an embodiment of the battery pack 14 of FIG. 1, including the housing 15 and various componentry disposed in the housing interior 17 defined by the housing 15. The componentry includes, for example, a first stack 24a (or interconnected group) of electrochemical cells 16a, a second stack 24b (or interconnected group) of electrochemical cells 16b, and the electronics compartment 28 between the first stack 24a and the second stack 24b. It should be noted that, for purposes of clarity and brevity, certain features illustrated in the battery pack 14 of FIG. 1 (e.g., the terminals 18, 20, the bus bars 22, and the connector(s) 26) are excluded in FIG. 2. However, it should be understood that the terminals 18, 20, the bus bars 22, and/or the connectors 26 may be employed in the battery pack 14 illustrated in FIG. 2.

In the illustrated embodiment, a first structural beam 30 (e.g., first longitudinal beam) and a second structural beam 32 (e.g., second longitudinal beam) may be disposed in the housing interior 17 along a length 34 of the battery pack 14. The first structural beam 30 and the second structural beam 32 may define regions of the housing interior 17, including a first region 36 configured to receive the first stack 24a of electrochemical cells 16a, a second region 38 configured to receive the second stack 24b of electrochemical cells 16b, and a third region referred to by the present disclosure as the electronics compartment 28. In the way, the first stack 24a of electrochemical cells 16a may be stacked in the first region 36 along the length 34 of the battery pack 14, and the second stack 24b of electrochemical cells 16b may be stacked in the second region 38 along the length 34 of the battery pack 14. The electronics compartment 28 may be configured to receive various electronic componentry of the battery pack 14, including, for example, a mid-pack unit (MPU) assembly, a power distribution unit (PDU) assembly, a power conversion system (PCS) assembly, and others. As shown, the electronics compartment 28 extends along substantially all of the length 34 of the battery pack 14. In certain embodiments, the electronics compartment 28 may extend along 50% or more, 70% or more, 75% or more, 80% or more, 90% or more, up to 100%, and so on, of the length 34 of the battery pack 14. In additional or alternative embodiments, the electronics compartment 28 may extend past the length 34 of the battery pack 14. It should be noted that, in some embodiments, the length 34 of the battery pack 14 may substantially correspond to a length of the housing 15 (e.g., the housing 15 may define the outer bounds of the battery pack 14). In other embodiments, componentry may be disposed on outer surfaces of the housing 15 that contribute to the length 34 of the battery pack 14, such that the length 34 of the battery pack 14 is larger (e.g., 1-20% larger) than a length of the housing 15.

Further to the points above, dividing walls may be disposed in the electronics compartment 28 to divide the electronics compartment 28 into various electronics compartment regions. For example, as shown, a first dividing wall 40 and a second dividing wall 42 may extend between the first and second structural beams 30, 32, and may be oriented along a width 44 of the battery pack 14 extending transverse to the length 34 of the battery pack 14, such that the first dividing wall 40 and the second dividing wall 42 divide the electronics compartment 28 into a first electronics compartment region 46, a second electronics compartment region 48, and a third electronics compartment region 50. As described in detail with reference to FIG. 3, each of the electronics compartment regions 46, 48, 50 may be configured to receive specific electronic componentry of the battery pack 14.

The battery pack 14 may also include a top panel 52, as shown. The top panel 52 may be considered a part of the housing 15. For example, the top panel 52 of the housing 15 may be configured to couple to a base 53 of the housing 15 to enclose the first stack 24a of electrochemical cells 16a, the second stack 24b of electrochemical cells 16b, electronic componentry, and other componentry in the housing interior 17. As shown, the top panel 52 may include a channel 54 defined on a surface 55 of the top panel 52 facing outwardly from the housing interior 17. The channel 54 may be configured to receive various harness assemblies that extend external to the housing 15 of the battery pack 14. The harness assemblies, for example, may correspond to aspects of a load powered by the battery pack 14. In particular, the channel 54 may include a depth (described in detail with reference to FIG. 5) that enables placement of the harness assemblies within the channel 54 without extending past the surface 55 of the top panel 52. As shown, the channel 54 defined in the top panel 52 may align with the electronics compartment 28 relative to the width 44 of the battery pack 14. Further, the channel 54 may extend along a majority of the length 34 (e.g., 50% or more, 70% or more, 75% or more, 80% or more, 90% or more, up to 100%, and so on, of the length 34) of the battery pack 14. Additionally or alternatively, the top panel 52 may include a top panel length 57, where the channel 54 runs along a majority of the top panel length 57 (e.g., 50% or more, 70% or more, 75% or more, 80% or more, 90% or more, up to 100%, and so on, of the top panel length 57). In the illustrated embodiment, the top panel length 57 may substantially correspond to the length 34 of the battery pack 14, although the top panel length 57 and the length 34 of the battery pack 14 may deviate from each other in other embodiments.

In some embodiments, the top panel 52 of the battery pack 14 may be substantially flat (e.g., planar) other than the channel 54, although certain componentry may be disposed on top of the top panel 52. Thus, the electronics compartment 28 and electronic componentry disposed in the electronics compartment 28, which may be aligned with (e.g., overlapping) the channel 54 as shown, may not add to a height 56 of the battery pack 14. In other words, a volume of the electronics compartment 28 may be distributed through the length 34 of the battery pack 14 such that the electronics compartment 28 and electronic componentry do not contribute to the height 56 of the battery pack 14. Put differently, the height 56 of the battery pack 14 may be designed to accommodate the first stack 24a of electrochemical cells 16a and the second stack 24b of electrochemical cells 16b, and inclusion of the electronics compartment 28 (and associated electronic componentry) does not require that the height 56 be substantially increased. Further, the electronics compartment 28 may extend from a bottom panel 58 (more clearly illustrated in FIG. 3) of the battery pack 14 to the top panel 52 of the battery pack 14.

As described in detail below, the bottom panel 58 may include an access portion configured to enable direct access to the electronics compartment 28 for maintenance and/or repair purposes and from underneath the battery pack 14. Indeed, electronic componentry of the battery pack 14 may be the most likely componentry to be maintained and/or repaired, or the componentry that may most frequently be maintained and/or repaired. Further, in certain embodiments, the battery pack 14 may be disposed in a cavity or space corresponding to a load that does not provide a sufficient clearance along the top panel 52 of the battery pack 14 for accessing the housing interior 17 through the top panel 52 without substantial disassembly of aspects of the load and/or the battery pack 14. Accordingly, the battery pack 14 in FIG. 2 may package the electronics compartment 28 in a manner that does not substantially contribute to the height 56 of the battery pack 14, as described above, and that enables improved access to the electronics compartment 28 for maintenance and repair. These and other features are described in detail below with reference to later drawings.

FIG. 3 is an exploded bottom perspective view of an embodiment of the battery pack 14 of FIG. 2. In the illustrated embodiment, the housing 15 of the battery pack 14 includes the bottom panel 58 having an access opening 70 aligned with the electronics compartment 28 (including the first electronics compartment region 46, the second electronics compartment region 48, the third electronics compartment region 50, and the dividing walls 40, 42). An access panel 72 may be configured to couple to the bottom panel 58 to close the access opening 70 during operation of the battery pack 14. For example, fasteners (e.g., screws, bolts, tabs, and so on) may be employed to couple the access panel 72 to the bottom panel 58 via fastener openings 74 in the access panel 72 and fastener openings 76 in the bottom panel 58, although other coupling mechanisms are also possible. The access panel 72 may be removed during maintenance, repair, and/or servicing procedures to facilitate access to the electronics compartment 28.

For example, in the illustrated embodiment, a power conversion system (PCS) assembly 78 may be disposed in the first electronics compartment region 46, a mid-pack unit (MPU) assembly 80 may be disposed in the second electronics compartment region 48, and a power distribution unit (PDU) assembly 82 may be disposed in the third electronics compartment region 50. Accordingly, removal of the access panel 72 from the bottom panel 58 may enable access to the PCS assembly 78, the MPU assembly 80, and the PDU assembly 82. However, other arrangements of the PCS assembly 78, the MPU assembly 80, and the PDU assembly 82 are also possible in accordance with the present disclosure. Further, other electronic componentry may be disposed in the electronics compartment 28 and may be readily accessible for maintenance, repair, and/or servicing via removal of the access panel 72. As previously described, the electronics compartment 28 may extend along a majority of the length 34 (e.g., 75% or more of the length 34) of the battery pack 14. Further, the electronics compartment 28 may extend between the bottom panel 58 and the top panel (not shown) along a majority of the height 56 (e.g., 50% or more, 70% or more, 75% or more, 80% or more, 90% or more, up to 100%, and so on, of the height 56) of the battery pack 14. The position, orientation, and size of the electronics compartment 28 as shown and described herein may be employed to reduce the height 56 of the battery pack 14 relative to traditional embodiments and/or improve accessibility (e.g., to electronic componentry in the electronics compartment 28) relative to traditional embodiments.

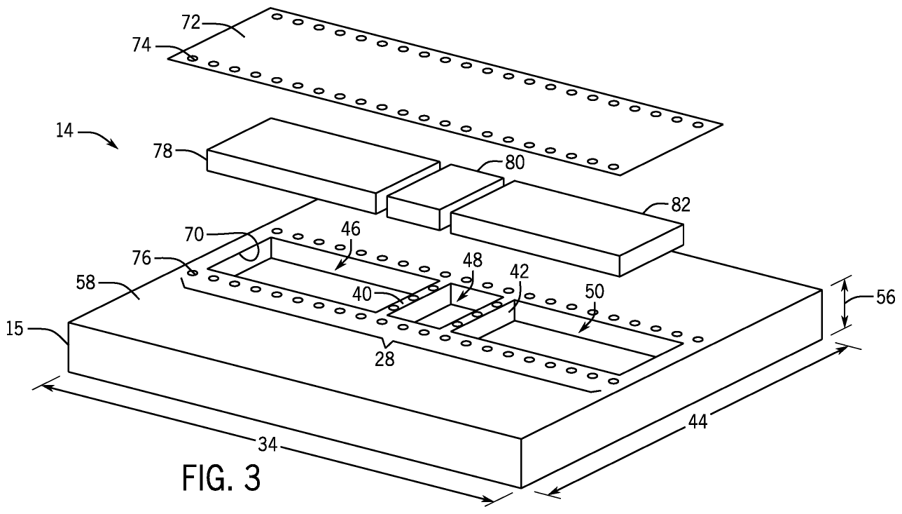

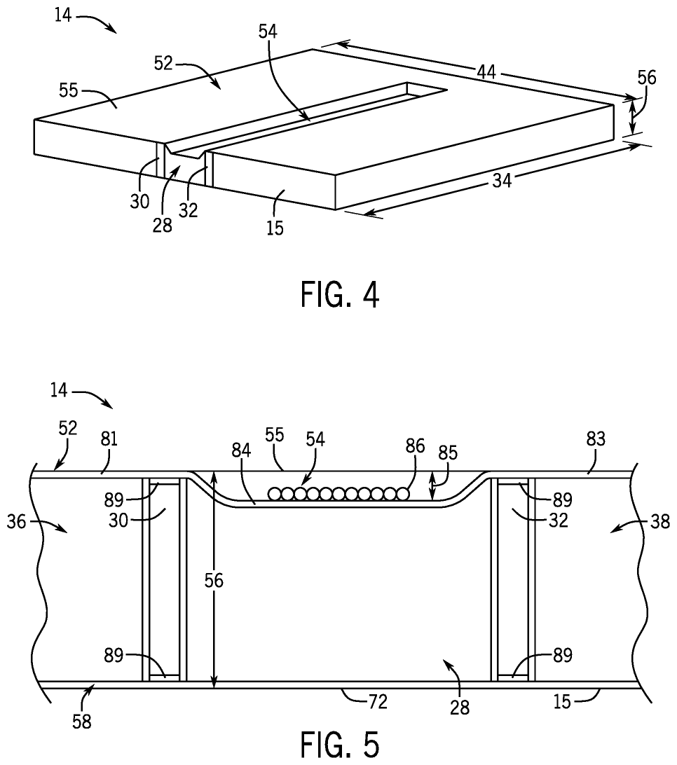

FIG. 4 is a top cross-sectional perspective view and FIG. 5 is a cross-sectional front view of an embodiment of the battery pack 14 of FIG. 2. As previously described, the battery pack 14 includes the channel 54 defined in the top panel 52 of the housing 15 of the battery pack 14 and extending along the length 34 of the battery pack 14. Further, the channel 54 is aligned with the electronics compartment 28 (e.g., relative to the width 44 of the battery pack 14), where the electronics compartment 28 is defined between the first longitudinal beam 30 and the second longitudinal beam 32 of the battery pack 14. Focusing on FIG. 5, for example, the top panel 52 includes a first portion 81 (e.g., first generally flat portion), a second portion 83 (e.g., second generally flat portion), and a third portion 84 defining the channel 54. For example, the third portion 84 may extend from the first portion 81 and the second portion 83 toward an opposing side of the battery pack 14 (e.g., toward the bottom panel 58 and/or the access panel 72 coupled to the bottom panel 58). In general, the channel 54 may be configured to receive one or more harness assemblies 86 associated with the battery pack 14 or an aspect of the load(s) receiving power from the battery pack 14.

The channel 54 may include a depth 85 that is sized to receive the one or more harness assemblies 86. For example, the depth 85 may be approximately 20 to 40 millimeters deep or 25 to 35 millimeters deep, depending on the embodiment. However, it should be noted that the battery pack 14 may be scaled up or down in size in certain embodiments. Thus, a ratio between the depth 85 of the channel 54 and the height 56 of the battery pack 14 (or the height 56 of the housing 15 of the battery pack 14) may be within a range of 1:10 to 1:5. That is, the depth 85 of the channel 54 may be between 10% and 20% of the height of the battery pack 14.

As previously described, the longitudinal beams 30, 32 of the battery pack 14 may define the first region 36, the second region 38, and the electronics compartment 28 of the battery pack 14. A first stack of electrochemical cells (not shown) may be disposed in the first region 36, a second stack of electrochemical cells (not shown) may be disposed in the second region 38, and electronic componentry (not shown) may be disposed in the electronics compartment 28. In addition to separating the electronics compartment 28 from the first region 36 and the second region 38, the longitudinal beams 30, 32 may provide structural support against a mechanical load exerted on the top panel 52 of the housing 15 of the battery pack 14. In some embodiments, a sealing assembly may be employed to seal the electronics compartment 28 from the first region 36 and the second region 38 (e.g., to block fluid ingress into the electronics compartment 28). For example, the sealing assembly may include various sealing components 89 that interface with the longitudinal beams 30, 32 and/or the housing 15 of the battery pack 14. The sealing components 89 may include, for example, fasteners, adhesives, gaskets, and/or other features that interface with the longitudinal beams 30, 32 and the housing 15 (e.g., the top panel 52, the bottom panel 58, and/or the access panel 72) to block fluid ingress into the electronics compartment (e.g., from the first and/or second regions 36, 38).

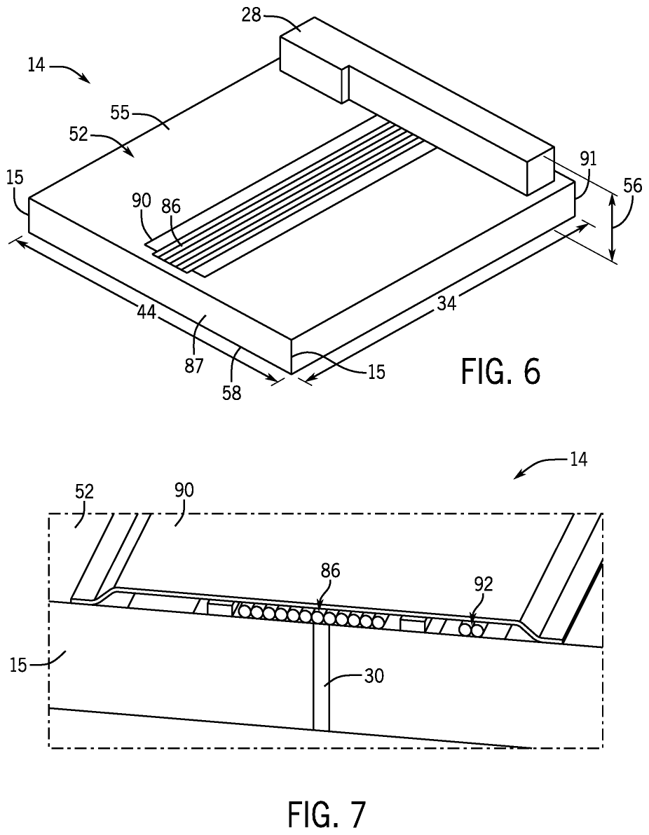

FIG. 6 is a top cross-sectional perspective view of an embodiment of the battery pack 14 of FIG. 1, where the electronics compartment 28 is disposed on the top panel 52 of the housing 15 of the battery pack 14 and extends along the width 44 of the battery pack. That is, the electronics compartment 28 in the illustrated embodiment extends along a majority of the width 44 (e.g., 50% or more, 70% or more, 75% or more, 80% or more, 90% or more, up to 100%, and so on, or more of the width 44) of the battery pack 14. Accordingly, in the illustrated embodiment, access to the electronics compartment 28 is provided at a top of the battery pack 14. While the electronics compartment 28 is illustrated adjacent to a back end or panel 91 of the housing 15, it should be understood that the electronics compartment 28 may be disposed adjacent to a front end or panel 87 of the housing 15 in another embodiment.

Although inclusion of the electronics compartment 28 on the top panel 52 of the housing 15 may contribute to the height 56 of the battery pack 14, inclusion of the electronics compartment 28 on the top panel 52 of the battery pack 14 may also increase an amount of room for electrochemical cells within the housing 15. For example, in FIGS. 2-5, the electronics compartment 28 is disposed between two stacks of electrochemical cells, whereas in FIG. 6, electrochemical cells may fill the middle region of the housing 15. Additionally or alternatively, the width 44 of the battery pack 14 in FIG. 6 may be less than the width 44 of the battery pack 14 in FIGS. 2-5, and/or the length 34 of the battery pack 14 in FIG. 6 may be less than the length 34 of the battery pack 14 in FIG. 6.

As shown in FIG. 6, one or more harness assemblies 86 may be disposed along the top panel 52 of the housing 15. Further, a lid 90 may be disposed over the one or more harness assemblies 86. The lid 90 is more clearly illustrated in FIG. 7, a cross-sectional perspective view of an embodiment of the battery pack 14 of FIG. 6. As shown, the lid 90 may be coupled to the top panel 52 of the housing 15 and configured to protect the one or more harness assemblies 86 running along the top panel 52 of the housing 15. As previously described, certain of the one or more harness assemblies 86 may belong to the load(s) powered by the battery pack 14. For example, the one or more harness assemblies 86 may include electrical wiring, fluid conduits, and the like. In certain embodiments, a portion 92 of the one or more harness assemblies 86 may belong to the battery pack 14. For example, the portion 92 may include electrical wiring associated with operation of the battery pack 14, coupling of the battery pack 14 with the one or more loads, etc.

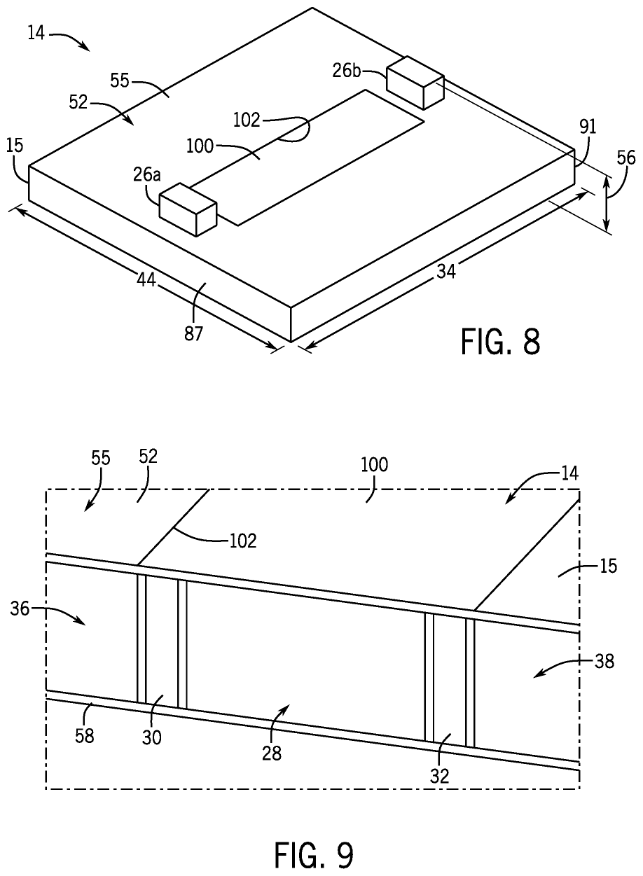

FIG. 8 is a top cross-sectional perspective view of an embodiment of the battery pack 14 of FIG. 1, including a top access panel 100 coupled to the top panel 52 of the housing 15 of the battery pack 14. For example, the top access panel 100 is coupled to the top panel 52 about a top access opening 102 in the top panel 52. Further, a first connector 26a and a second connector 26b are positioned on the top panel 52 in the illustrated embodiment. The first connector 26a may be configured to couple the battery pack 14 to a first load and the second connector 26b may be configured to couple the battery pack 14 to a second load. Although the various embodiments of the battery pack 14 in FIGS. 2-7 do not illustrate connectors, it should be understood that connectors may be employed in these embodiments. Further, connectors may be positioned on any panel of the housing 15, including the back panel 91 and/or the front panel 87.

FIG. 9 is a cross-sectional perspective view of an embodiment of the battery pack 14 of FIG. 8. As is the case in certain previously described embodiments of the battery pack 14, the embodiment in FIG. 9 includes the electronics compartment 28, first longitudinal beam 30 positioned between the electronics compartment 28 and the first region 36 of the battery pack 14, and the second longitudinal beam 32 positioned between the electronics compartment 28 and the third region 38 of the battery pack 14. The longitudinal beams 30, 32 may extend from the top panel 52 of the housing 15 to the bottom panel 58 of the housing 15, such that the longitudinal beams 30, 32 support a mechanical load against the top panel 52 (and/or the top access panel 100) of the housing 15.

FIG. 10 is a top cross-sectional perspective view of an embodiment of the battery pack 14 of FIG. 1, including various electronics compartments 28a, 28b, 28c disposed on (or extending through) the top panel 52 of the housing 15 of the battery pack 14 and extending along the length 34 of the battery pack 14. Each electronics compartment 28a, 28b, 28c may be configured to receive electronics componentry of the battery pack 14. In some embodiments, the electronics compartments 28a, 28b, 28c may be attached to the surface 55 of the top panel 52 of the housing 15. In other embodiments, the electronics compartments 28a, 28b, 28c may extend through an opening in the top panel 52. As shown, electronics compartment lids 110a, 110b, 110c may be disposed over the electronics compartments 28a, 28b, 28c to protect the electronic componentry within the electronics compartments 28a, 28b, 28c.

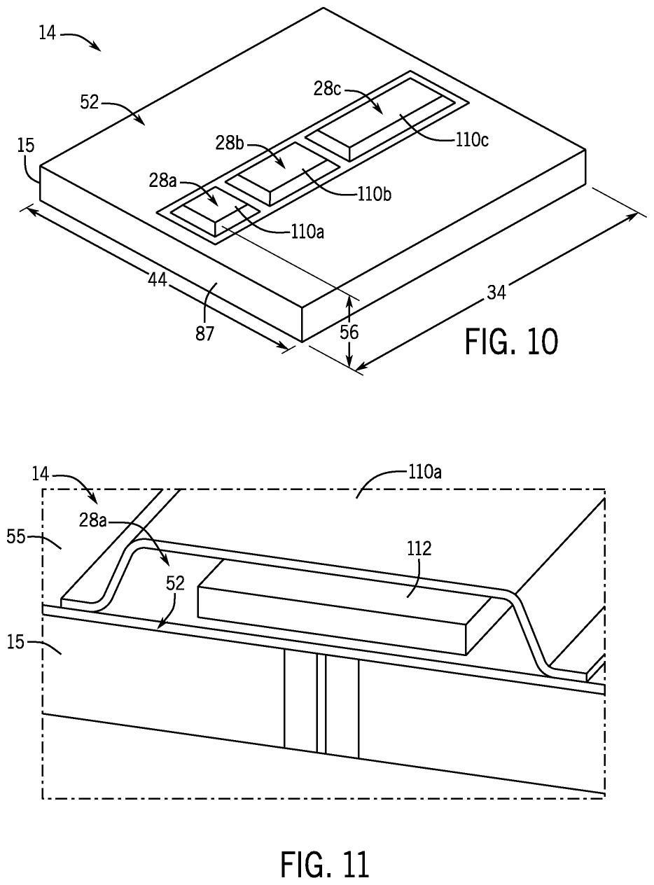

Further, FIG. 11 is a cross-sectional perspective view of an embodiment of the battery pack 14 of FIG. 10. As shown in FIG. 11, an electronic component 112 (e.g., a printed circuit board (PCB), a PDU assembly, an MPU assembly, a power conversion system, or the like) may be disposed in the electronics compartment 28a and protected via the lid 110a corresponding to the electronics compartment 28a. Further, similar to the battery pack 14 illustrated in FIGS. 6 and 7, inclusion of the electronics compartments 28a, 28b, 28c on along the top panel 52 of the battery pack 14 illustrated in FIGS. 10 and 11 may include increase an amount of room for electrochemical cells within the housing 15. For example, electrochemical cells may fill a middle region within the housing 15 of the battery pack 14 in FIGS. 10 and 11.

The present disclosure is directed toward various embodiments of a battery pack that provide various technical benefits over traditional systems and methods, including improved serviceability of electronics componentry, improved structural integrity, improved volumetric energy density, and/or reduced height, among other benefits.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A battery pack, comprising:
a housing defining a housing interior;
a first stack of electrochemical cells disposed in the housing interior;
a second stack of electrochemical cells disposed in the housing interior; and
an electronics compartment disposed in the housing interior, positioned between the first stack of electrochemical cells and the second stack of electrochemical cells, and extending along a majority of a length of the battery pack.

2. The battery pack of claim 1, wherein the housing comprises a panel and the panel comprises:
a first flat portion aligned with the first stack of electrochemical cells;
a second flat portion aligned with the second stack of electrochemical cells; and
a third portion aligned with the electronics compartment and extending from the first flat portion and the second flat portion toward an opposing side of the housing such that the third portion defines a channel, the channel being defined along a surface of the panel facing outward from the housing interior.

3. The battery pack of claim 2, wherein the opposing side of the housing comprises an access panel.

4. The battery pack of claim 1, comprising at least one dividing wall disposed in the electronics compartment and extending along a width of the battery pack transverse to the length, the at least one dividing wall defining regions of the electronics compartment.

5. The battery pack of claim 1, comprising a power distribution unit (PDU) assembly, a mid-pack unit (MPU) assembly, and a power conversion system disposed in the electronics compartment.

6. The battery pack of claim 1, comprising:
a first longitudinal beam disposed between the first stack of electrochemical cells and the electronics compartment; and
a second longitudinal beam disposed between the second stack of electrochemical cells and the electronics compartment.

7. The battery pack of claim 6, comprising a sealing assembly configured to interface with the first longitudinal beam, the second longitudinal beam, or both, such that the sealing assembly seals the electronics compartment from a first cavity of the housing interior in which the first stack of electrochemical cells is disposed and a second cavity of the housing interior in which the second stack of electrochemical cells is disposed.

8. The battery pack of claim 1, comprising:
a first connector assembly aligned with a first end of the electronics compartment; and
a second connector assembly aligned with a second end of the electronics compartment, the second end opposing the first end.

9. The battery pack of claim 1, wherein the electronics compartment comprises an electronics compartment length that is at least 75% of the length.

10. A battery pack, comprising:
a plurality of electrochemical cells; and
a housing defining a housing interior in which the plurality of electrochemical cells is disposed, wherein the housing comprises a panel having a first flat portion, a second flat portion, and a third portion disposed between the first flat portion and the second flat portion, and wherein the third portion extends from the first flat portion and the second flat portion toward an opposing panel of the housing such that the third portion defines a channel, the channel being defined along a surface of the panel facing outwardly from the housing interior.

11. The battery pack of claim 10, wherein:
the panel comprises a first length extending in a direction from a first end of the housing to a second end of the housing; and
the third portion of the panel comprises a second length extending in the direction, and the second length is at least 75% of the first length.

12. The battery pack of claim 10, comprising:
a first electrochemical cell stack comprising a first portion of the plurality of electrochemical cells;
a second electrochemical cell stack comprising a second portion of the plurality of electrochemical cells; and
an electronics compartment disposed between the first electrochemical cell stack and the second electrochemical cell stack.

13. The battery pack of claim 12, wherein the electronics compartment extends along at least 75% of a length of the battery pack and at least 75% of a height of the battery pack.

14. The battery pack of claim 12, wherein:
the first flat portion of the panel is aligned with the first electrochemical cell stack;
the second flat portion of the panel is aligned with the second electrochemical cell stack; and
the third portion of the panel is aligned with the electronics compartment.

15. The battery pack of claim 10, wherein the opposing panel comprises an access panel.

16. A battery pack, comprising:
a housing defining a housing interior;
a plurality of electrochemical cells disposed in the housing interior;
a first panel of the housing;
a second panel of the housing, wherein the second panel opposes the first panel;
an access panel of the housing, wherein the access panel is coupled to the second panel about an access opening in the second panel; and
structural beams extending through the housing interior between the first panel and the second panel to support a mechanical load against the first panel.

17. The battery pack of claim 16, comprising:
a first electrochemical cell stack having a first portion of the plurality of electrochemical cells;
a second electrochemical cell stack having a second portion of the plurality of electrochemical cells; and
an electronics compartment disposed in the housing interior and extending between the first electrochemical cell stack and the second electrochemical cell stack.

18. The battery pack of claim 17, wherein the structural beams comprise:
a first longitudinal beam disposed between the first electrochemical cell stack and the electronics compartment; and
a second longitudinal beam disposed between the second electrochemical cell stack and the electronics compartment.

19. The battery pack of claim 17, wherein the first panel comprises:
a first flat portion aligned with the first electrochemical cell stack;
a second flat portion aligned with the second electrochemical cell stack; and
a third portion aligned with the electronics compartment and extending from the first flat portion and the second flat portion toward the access panel of the housing such that the third portion defines a channel along an outward facing surface of the first panel.

20. The battery pack of claim 16, comprising an electronics compartment disposed above the first panel.
